(19) United States
(12) Patent Application Publication
(10) Pub. No.: US 2026/0200022 A1
(43) Pub. Date: Jul. 16, 2026

(54) Joint Pipe-Assembling Machine

(71) Applicant: Guofen Luo, Dongguan City (CN)

(72) Inventor: Guofen Luo, Dongguan City (CN)

(21) Appl. No.: 19/015,642

(22) Filed: Jan. 10, 2025

(51) Int. Cl. B23P 19/06

(52) U.S. Cl. CPC B23P 19/061

(57) ABSTRACT

A joint pipe-assembling machine comprises a machine base. One end has a pipe body clamping device; the other end has a joint clamping and connecting device with a rotation assembly and a joint clamping mold. In use, fix the pipe body in the pipe clamping device, mount the joint on the rotation assembly, and place the pipe's other end into the joint clamping mold. By rotating the assembly, the joint is connected to the pipe. Next, reverse the hose joint element, place its pipe body end on the rotation assembly and fix its other end in the joint clamping mold, then install a smaller bent pipe joint in the pipe clamping device. Rotating again connects the hose joint element and the smaller bent pipe joint. Multiple connections are enabled, improving efficiency and quality.

### FIELD OF THE INVENTION

The present invention relates to the technical field of connecting a pipe and a joint, and in particular to a joint pipe-assembling machine.

### BACKGROUND OF THE INVENTION

Currently, when a pipe body and a joint are connected, they are generally rotated and connected manually. Due to the fact that the joint includes L-shaped, U-shaped, C-shaped, and other curved structures, manual rotation for connection is inconvenient, can easily cause hand injuries, and does not achieve a sufficiently firm connection. Of course, some people use manual operations in combination with wrenches or other tools to achieve rotational connection. However, for certain special curved structures and slender pipe bodies, wrenches and other tools are not convenient for clamping or can cause damage to both the pipe body and the joint during clamping and connection.

In order to solve the above problems, prior art includes fixing the pipe body and the joint on a clamping device; however, these types of clamping devices do not match the shape of the pipe body and the joint well, making clamping inconvenient. Moreover, in the process of connecting the pipe body and the joint, it is also inconvenient to perform rotational connection, leading to low efficiency. In addition, such connection merely achieves a one-time connection between the pipe body and the joint. For situations requiring another joint (e.g., a curved pipe joint) to be connected again on the already-connected hose joint element, the hose joint element and the pipe joint are not easily clamped, making connection between the hose joint element and the curved pipe joint inconvenient.

### SUMMARY OF THE INVENTION

The purpose of the present invention is to provide a joint pipe-assembling machine, in which the pipe body and the joint can be conveniently clamped, multiple connection operations can be performed, and the connection operation is simple and convenient, thereby effectively improving the efficiency and quality of connecting the pipe body with the joint.

In order to solve the above technical problems, the present invention achieves the solution through the following technical proposal: A joint pipe-assembling machine, comprising a machine base. One end of the machine base is provided with a pipe body clamping device, and the other end of the machine base is provided with a joint clamping and connecting device. The joint clamping and connecting device comprises a rotation connecting assembly. One end of the rotation connecting assembly is connected to a joint clamping mold. One end of the pipe body is clamped in the pipe body clamping device, and the other end extends into the joint clamping mold for connection with the joint.

Preferably, the pipe body clamping device comprises a sliding slot formed on the machine base. A left clamp block and a right clamp block are arranged in the sliding slot. A support block is arranged at the lower portion between the left clamp block and the right clamp block. A left tooth sleeve and a right tooth sleeve are respectively connected to the upper front ends between the left clamp block and the right clamp block. A tightness adjustment screw is arranged between the left clamp block and the right clamp block, and the outer end of the tightness adjustment screw is connected to a tightness adjustment control lever.

More preferably, an arc-shaped slot is formed in the upper portion of the left clamp block and the right clamp block. A connecting hole is formed in the arc-shaped slot. The left tooth sleeve and the right tooth sleeve each comprise a sleeve body, a lap plate is provided on the upper end of the sleeve body, and a connecting post configured to cooperate with the connecting hole is provided in the middle of the sleeve body.

More preferably, the rotation connecting assembly comprises a clamping seat provided on the machine base. A rotation slot is formed in the middle of the clamping seat, and a rotation cylinder is installed in the rotation slot. One end of the rotation cylinder is provided with a rotation head, and the joint clamping mold is connected to the other end of the rotation cylinder.

More preferably, an inner slot is formed in the rotation cylinder, and a locking buckle is hinged on the rotation head.

More preferably, a rotation control lever is inserted through one end of the rotation cylinder corresponding to the rotation head.

More preferably, the joint clamping mold comprises a clamping seat connected to the rotation cylinder. A clamping upper cover is hinged on the clamping seat, and a spiral open-close key is arranged between the clamping upper cover and the clamping seat. A joint clamping upper mold base and a joint clamping lower mold base are arranged within the clamping upper cover and the clamping seat.

More preferably, positioning holes are formed in the inner walls of the clamping upper cover and the clamping seat, and positioning posts configured to cooperate with the positioning holes are provided on the outer walls of the joint clamping upper mold base and the joint clamping lower mold base.

Beneficial effects of the present invention: It comprises a machine base. One end of the machine base is provided with a pipe body clamping device, and the other end of the machine base is provided with a joint clamping and connecting device. The joint clamping and connecting device comprise a rotation connecting assembly, and one end of the rotation connecting assembly is connected to a joint clamping mold. One end of the pipe body is clamped in the pipe body clamping device, and the other end extends into the joint clamping mold for connection with the joint. In use, the pipe body is first installed and fixed in the pipe body clamping device, the joint is installed on the rotation connecting assembly, and the other end of the pipe body is extended into the joint clamping mold for fixing. Afterwards, by controlling the rotation connecting assembly together with the joint clamping mold and the joint to move toward the pipe body clamping device into place, it is then rotated to connect the joint with the pipe body. Next, after reversing the connected hose joint element (the pipe body and joint) in orientation, the pipe body end is installed in the rotation connecting assembly, and the other end is fixed in the joint clamping mold. A smaller curved pipe joint is then installed and fixed in the pipe body clamping device. By controlling the rotation connecting assembly together with the joint clamping mold and the hose joint element to move toward the pipe body clamping device into place, it is then rotated to connect the hose joint element with the smaller curved pipe joint. In this way, the pipe body and the joint can be conveniently clamped, multiple connection operations can be performed, the connection operation is simple and convenient, and the efficiency and quality of connecting the pipe body and the joint are effectively improved.

### BRIEF DESCRIPTION OF THE DRAWINGS

FIG. 1 is a structural schematic diagram of the present invention;

FIG. 2 is an exploded structural schematic diagram of the present invention.

### DETAILED DESCRIPTION OF THE EMBODIMENTS

Below, the present invention is described in further detail with reference to the accompanying drawings and examples.

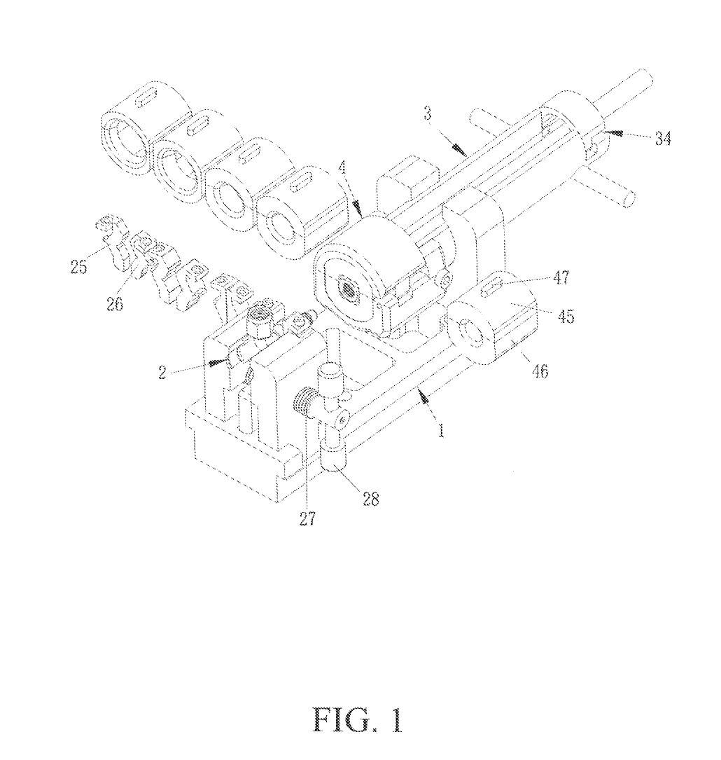

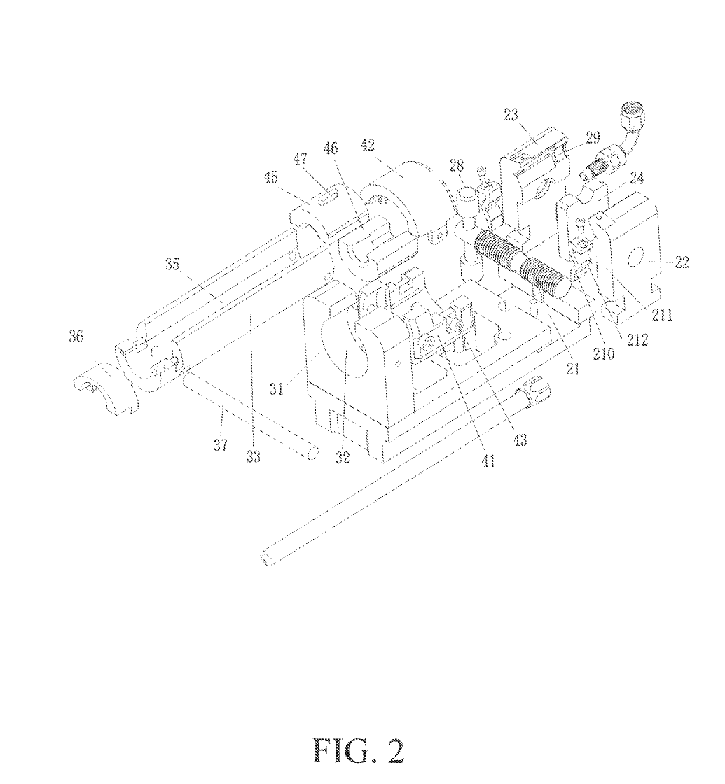

As shown in FIGS. 1 and 2, a joint pipe-assembling machine comprises a machine base 1. One end of the machine base 1 is provided with a pipe body clamping device 2, and the other end of the machine base 1 is provided with a joint clamping and connecting device. The joint clamping and connecting device comprise a rotation connecting assembly 3. One end of the rotation connecting assembly 3 is connected to a joint clamping mold 4, one end of the pipe body is clamped in the pipe body clamping device 2, and the other end extends into the joint clamping mold 4 to connect with the joint. In use, the pipe body is first installed and fixed in the pipe body clamping device 2, the joint is installed on the rotation connecting assembly 3, and the other end of the pipe body is extended into the joint clamping mold 4 for fixing. Afterwards, by controlling the rotation connecting assembly 3 together with the joint clamping mold 4 and the joint to move toward the pipe body clamping device 2 into place, it is then rotated to connect the joint with the pipe body. Next, after reversing the hose joint element (the pipe body and joint) in orientation, the pipe body end is installed in the rotation connecting assembly 3, and the other end is fixed in the joint clamping mold 4. A smaller curved pipe joint is then installed and fixed in the pipe body clamping device 2. By controlling the rotation connecting assembly 3 together with the joint clamping mold 4 and the hose joint element to move toward the pipe body clamping device 2 into place, it is then rotated to connect the hose joint element with the smaller curved pipe joint. In this way, without damaging the pipe body and the joint, the pipe body and the joint can be conveniently clamped, multiple connection operations can be performed, the connection operation is simple and convenient, and the efficiency and quality of connecting the pipe body and the joint are effectively improved.

In this embodiment, the pipe body clamping device 2 comprises a sliding slot 21 formed on the machine base 1. A left clamp block 22 and a right clamp block 23 are arranged in the sliding slot 21. A support block 24 is arranged at the lower portion between the left clamp block 22 and the right clamp block 23. A left tooth sleeve 25 and a right tooth sleeve 26 are respectively connected to the upper front ends between the left clamp block 22 and the right clamp block 23. A tightness adjustment screw 27 is arranged between the left clamp block 22 and the right clamp block 23, and the outer end of the tightness adjustment screw 27 is connected to a tightness adjustment control lever 28. An arc-shaped slot 29 is formed in the upper portion of the left clamp block 22 and the right clamp block 23, and a connecting hole is formed in the arc-shaped slot 29. The left tooth sleeve 25 and the right tooth sleeve 26 include a sleeve body 210, a lap plate 211 is provided on the upper end of the sleeve body 210, and a connecting post 212 configured to cooperate with the connecting hole is provided in the middle of the sleeve body 210. When clamping the pipe body, first rotate the tightness adjustment control lever 28 to make the tightness adjustment screw 27 rotate spirally, which in turn separates and opens the left clamp block 22 and the right clamp block 23, as well as the left tooth sleeve 25 and the right tooth sleeve 26. Then place the pipe body between the left tooth sleeve 25 and the right tooth sleeve 26. Next, rotate the tightness adjustment control lever 28 so that the tightness adjustment screw 27 rotates spirally, thereby bringing the left clamp block 22 and the right clamp block 23, as well as the left tooth sleeve 25 and the right tooth sleeve 26, closer together to clamp the pipe body. The pipe body is thus tightly clamped through the matching of the left tooth sleeve 25 and the right tooth sleeve 26, providing protection and avoiding damage to the pipe body. The left tooth sleeve 25 and the right tooth sleeve 26 can be provided in multiple types to correspond to different sizes and cross-sectional shapes of the pipe body. When being connected to the left clamp block 22 and the right clamp block 23, one can flexibly choose a suitable type according to the actual situation. Of course, based on actual operation considerations, the left tooth sleeve 25 and the right tooth sleeve 26 may not be adopted, and instead the pipe body may be directly clamped by means of the arc-shaped slot 29 in the left clamp block 22 and the right clamp block 23.

In this embodiment, the rotation connecting assembly 3 comprises a clamping seat 31 provided on the machine base 1. A rotation slot 32 is formed in the middle of the clamping seat 31, and a rotation cylinder 33 is installed in the rotation slot 32. One end of the rotation cylinder 33 is provided with a rotation head 34, the joint clamping mold 4 is connected to the other end of the rotation cylinder 33, and a rotation control lever 37 is inserted through one end of the rotation cylinder 33 corresponding to the rotation head 34. The joint clamping mold 4 comprises a clamping seat 41 connected to the rotation cylinder 33, a clamping upper cover 42 hinged on the clamping seat 41, a spiral open-close key 43 arranged between the clamping upper cover 42 and the clamping seat 41, and a joint clamping upper mold base 45 and a joint clamping lower mold base 46 arranged within the clamping upper cover 42 and the clamping seat 41. Positioning holes are formed in the inner walls of the clamping upper cover 42 and the clamping seat 41, and positioning posts 47 configured to cooperate with the positioning holes are provided on the outer walls of the joint clamping upper mold base 45 and the joint clamping lower mold base 46. The joint clamping upper mold base 45 and the joint clamping lower mold base 46 can be provided in multiple types to correspond to different sizes and cross-sectional shapes of the joint and the pipe body. When being connected to the clamping seat 41 and the clamping upper cover 42, one can flexibly choose a suitable type according to the actual situation. When clamping the joint, first open the clamping upper cover 42 using the spiral open-close key 43, then remove the joint clamping upper mold base 45 from the joint clamping lower mold base 46, place the joint and the other end of the pipe body inside the joint clamping lower mold base 46, then arrange the joint clamping upper mold base 45 in cooperation with the joint clamping lower mold base 46, rotate the clamping upper cover 42 to close it with the clamping seat 41, and lock the clamping upper cover 42 and the clamping seat 41 using the spiral open-close key 43. Finally, one can hold the rotation head 34 or control the rotation control lever 37 to rotate the rotation cylinder 33, the joint clamping mold 4, and the joint together, thereby achieving a connection between the joint and the pipe body to form a hose joint element.

In this embodiment, the inner slot 35 is formed in the rotation cylinder 33, and a locking buckle 36 is hinged on the rotation head 34. In this embodiment, the pipe body and the straight joint can form a hose joint element by the above method. Afterward, flip the hose joint element, place its pipe body portion into the inner slot 35 of the rotation cylinder 33, clamp one end with the locking buckle 36, clamp the other end with the joint clamping mold 4, and choose the corresponding type of the joint clamping upper mold base 45 and the joint clamping lower mold base 46. Reverse the setup to place them between the clamping seat 41 and the clamping upper cover 42. Meanwhile, a smaller curved pipe joint is clamped in the pipe body clamping device 2 (this smaller curved pipe joint can be screwed into the joint of the previously connected hose joint element). Once the hose joint element and the smaller curved pipe joint are clamped, the clamping seat is used for support. The rotation cylinder 33, the clamping seat 41, the clamping upper cover 42, the joint clamping upper mold base 45, the joint clamping lower mold base 46, and the hose joint element are driven together to move toward the smaller curved pipe joint on the pipe body clamping device 2. Finally, control the rotation cylinder 33 to rotate the clamping seat 41, the clamping upper cover 42, the joint clamping upper mold base 45, the joint clamping lower mold base 46, and the hose joint element together to achieve the connection between the hose joint element and the smaller curved pipe joint.

In light of the concept of the present invention, there will be variations in the specific embodiments and application scope. The content of this specification shall not be construed as limiting the present invention.

I claim:

1. A joint pipe-assembling machine, comprising:
a machine base;
wherein one end of the machine base is provided with a pipe body clamping device, and another end is provided with a joint clamping and connecting device;
the joint clamping and connecting device comprise a rotation connecting assembly; one end of the rotation connecting assembly is connected to a joint clamping mold.

2. The joint pipe-assembling machine according to claim 1, wherein the pipe body clamping device comprises a sliding slot formed on the machine base; a left clamp block and a right clamp block are arranged in the sliding slot; a support block is arranged at a lower portion between the left clamp block and the right clamp block; the upper front ends between the left clamp block and the right clamp block are respectively connected to a left tooth sleeve and a right tooth sleeve; a tightness adjustment screw is arranged between the left clamp block and the right clamp block; and the outer end of the tightness adjustment screw is connected to a tightness adjustment control lever.

3. The joint pipe-assembling machine according to claim 2, wherein an arc-shaped slot is formed in the upper portion of the left clamp block and the right clamp block; a connecting hole is formed in the arc-shaped slot; the left tooth sleeve and the right tooth sleeve each comprise a sleeve body; a lap plate is provided on an upper end of the sleeve body; and a connecting post configured to cooperate with the connecting hole is provided in the middle of the sleeve body.

4. The joint pipe-assembling machine according to claim 1, wherein the rotation connecting assembly comprises a clamping seat provided on the machine base; a rotation slot is formed in the middle of the clamping seat; a rotation cylinder is installed in the rotation slot; one end of the rotation cylinder is provided with a rotation head; and the joint clamping mold is connected to the other end of the rotation cylinder.

5. The joint pipe-assembling machine according to claim 4, wherein an inner slot is formed in the rotation cylinder; and a locking buckle is hinged on the rotation head.

6. The joint pipe-assembling machine according to claim 4, wherein a rotation control lever is inserted through one end of the rotation cylinder corresponding to the rotation head.

7. The joint pipe-assembling machine according to claim 4, wherein the joint clamping mold comprises a clamping seat connected to the rotation cylinder; a clamping upper cover is hinged on the clamping seat; a spiral open-close key is arranged between the clamping upper cover and the clamping seat; and a joint clamping upper mold base and a joint clamping lower mold base are arranged within the clamping upper cover and the clamping seat.

8. The joint pipe-assembling machine according to claim 7, wherein positioning holes are formed in the inner walls of the clamping upper cover and the clamping seat; and positioning posts configured to cooperate with the positioning holes are provided on the outer walls of the joint clamping upper mold base and the joint clamping lower mold base.
